(19) United States
(12) Patent Application Publication
(10) Pub. No.: US 2011/0307380 A1
(43) Pub. Date: Dec. 15, 2011

(54) System And Method For Establishing And Managing Social Wireless Network

(76) Inventor: Lieberman IDO, (US)

(21) Appl. No.: 12/813,198

(22) Filed: Jun. 10, 2010

(51) Int. Cl. G06F 15/16; G06Q 40/00; G01S 19/42

(52) U.S. Cl. 705/44; 709/206; 342/357.25; 709/227; 709/224

(57) ABSTRACT

A system for establishing connection between at least two electronic devices, through wireless communication data network, wherein each electronic device is associated with a single entity and at least one of the entities is a human user which participates in at least one social network. The system includes: a connection module supported by a short range communication protocol, integrated within at least one electronic device, wherein the module includes an identifying field uniquely associated with said electronic device and associated entity, the identification field is exposed as BT identity to other electronic devices located at proximity to said first device, wherein the identification field includes at least one unique code corresponding to said electronic device and at least one code associated with ID number of the entity in a social network, at least one repository of a cellular social network members, each member record including the identifying field, user profile and user connections to other entities, and wherein the connection module support handling the handshaking process of establishing social connection between two entities.

### FIELD OF INVENTION

The present invention relates in general to the field of social network service, more particularly it relates to systems and methods for creating and managing social network through wireless enabled devices.

### BACKGROUND OF THE PRIOR ART

The known social networks usually provide their members with virtual management of their relationship with their bodies. Most of the relationships in the existing social networks are loosely connected to the real world social and even professional relationships of its members. The data in the social network is mostly based on reports of the members. Creating connections between people located in the same geographical area is known in the art, but is limited to occasional occurrences not taking full advantage of available data and events taking place in the real world for creating new social connections and managing old one.

### SUMMARY OF INVENTION

A system for establishing connection between at least two electronic devices, through wireless communication data network, wherein each electronic device is associated with a single entity and at least one of the entities is a human user which participates in at least one social network. The system comprising: a connection module supported by a short range communication protocol, integrated within at least one electronic device, wherein the module includes an identifying field uniquely associated with said electronic device and associated entity, said identification field is exposed as BT identity to other electronic devices located at proximity to said first device, wherein the identification field includes at least one unique code corresponding to said electronic device and at least one code associated with ID number of the entity in a social network, at least one repository of a cellular social network members, each member record including the identifying field, user profile and user connections to other entities, wherein the connection module support handling the handshaking process of establishing social connection between two entities.

Thee connection method comprising: a detection module for measuring connection parameters of exposure time period, signal strength, distance, frequency of exposures between two electronic devices for initiating an handshaking process between two corresponding entities located in proximity to each other, —a matching module enabling to compare profiles of detected entities and notify at least one entity of a list of identified entities located in proximity having a relevant profile and according to detection module measurements, a presentation module for displaying the matching entities and their identifying field at the screen of the electronic device, a handshaking module enabling to send an introduction message using the short range communication protocol, and establishing connection to said second entity by receiving acknowledgment from said second entity, wherein upon establishing connection both entities are connected through a social cellular network, a social communication module enabling socially connected members to exchange messages information through alternative communication protocols using the BT identifier not limited to short range communication.

The system may use Bluetooth, WIFI, RF, Infra Red or for a short range protocol.

The system may further include connection algorithm enabling to evaluate connection parameters measurements and to combine at least two short range communication protocol including at least one of Bluetooth, WIFI, RF, Infra Red.

The system may use alternative communication protocols such as TCP/IP, WAP.

The electronic device may be passive electronic tag enabled to communicate only through short range communication protocol.

The electronic device may be a smart mobile device enabled to communicate through short range communication protocol and long range data wireless networks for exchanging electronic messages or information.

The electronic device may be a stationary device enabled to communicate only through short range and operatively associated with a computerized terminal.

The smart electronic device may functions as communication relay device enabling to establish social connection between two electronic devices located out of the short range communication protocol.

The smart device may include a management application enabling the associated entity to track pre-defined list of entities socially related to the first entity, and supervising their presence within predefined range.

The smart device may include a management application enabling the associated entity to track pre-defined list of entities socially connected to the first entity, and supervising their presence at any location in the range of at least one electronic device associated to entities socially connected to the first entity and having long distance communication with the electronic device of the first entity.

The system alternative communication platform may include at least one of the following communication applications: IM, SMS, emails and/or chat.

The system can further comprise a tracking module for locating entities associated with passive electronic devices, wherein a searching entity transmits a query to one or more bodies, to report it, in case a specific entity having a BT identity is located in proximity of one of the bodies' electronic device.

The electronic device can scans the nearby environment for locating bodies' electronic devices, wherein detected devices have direct connection through short range communication protocol to exchange messages and information.

The system may include a social communication module which provides the users with information of available communication platform for connecting available members, said information including communication cost, quality of connection, and speed of connection.

The electronic device may further include a module for calculating the direction of the received signals from near by electronic device enabling to limit the detection of available devices at predefine angles around the electronic device, utilizing at least one of: directional antennas, and a pair of antennas.

The system may further comprise a location module for expanding the use of the location based services for a requesting device in which the GPS is out of communication range, wherein the electronic device can locate available bodies in it's proximity in which the GPS unit is not blocked, when the available device the GPS location data is shared with the requesting device enabling it to use location based services.

The system may further comprising a payment module enabling authenticated payment by the electronic device, wherein the authenticated payment is achieved by replacing the BT identity for a short time period with authenticated ID number and transmitting said number to a designated second electronic device through a short communication protocol.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein;

FIG. 1 is a schematic illustration of the basic connectivity between entities and devices which the operate in accordance with embodiments of the present invention;

FIG. 2 is a block diagram of a smart mobile device in accordance with embodiments of the present invention;

FIG. 3 is a flowchart illustrating the process of establishing new connections between entities of the wireless network and the main services provided in accordance with embodiments of the present invention;

FIG. 4 is flowchart illustrating the process providing messages and information exchange platform between connected entities in accordance with embodiments of the present invention;

FIG. 5 is flowchart illustrating the process of management of relationship between connected entities in accordance with additional embodiments of the present invention;

FIG. 6 is flowchart illustrating the process of hardware and software resource allocation sharing between devices of socially related entities in accordance with additional embodiments of the present invention;

FIG. 7 is flowchart illustrating the process of expanding location based service of electronic device in accordance with additional embodiments of the present invention;

FIG. 8 is a block diagram of a passive mobile device in accordance with additional embodiments of the present invention;

FIG. 9 is a schematic illustration of the basic connectivity between a master entity, his bodies and devices which operate in accordance with additional embodiments of the present invention;

FIG. 10 is a flow chart illustrating the process of communication between a master entity, his bodies and devices which operate in accordance with additional embodiments of the present invention;

FIG. 11 is a schematic illustration of the basic connectivity between a manager entity, his bodies and devices which operate in accordance with additional embodiments of the present invention;

FIG. 12 is a flow chart illustrating the process of communication between a manger entity, his bodies and devices which operate in accordance with additional embodiments of the present invention; and

FIG. 13 is a flow chart illustrating the process of credit payment in accordance with additional embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

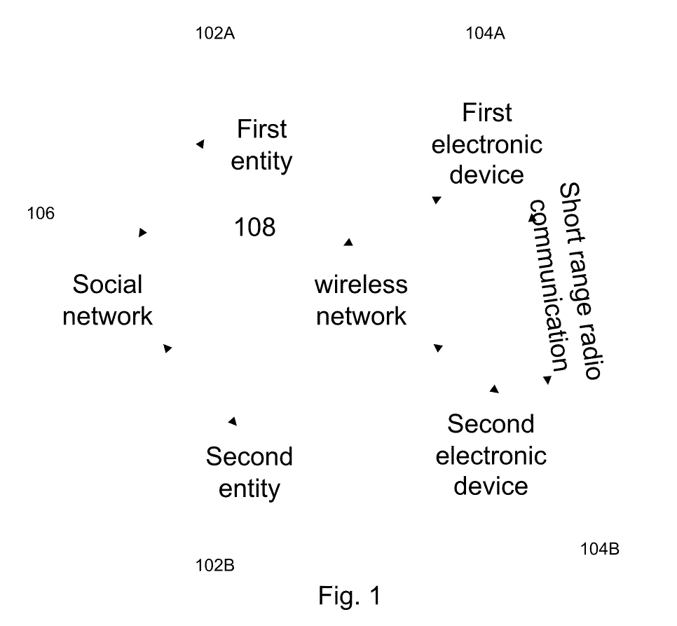

FIG. 1 is a schematic illustration of the basic connectivity between entities and devices which operate in accordance with embodiments of the present invention. Entities 102A and 102B according to the present invention may be human user or functional electronic objects such vehicle, electronic doors etc., which are controlled by a human user and are uniquely associated with a human user. Electronic devices 104A and 104B according to the present invention may be smart phones having advanced processing capabilities or passive devices such as electronic tags. All entities are logically connected through social networks 106 which include profile information of the entities, the social network may be existing social network or a dedicated wireless social network which is established according to the method and system as suggested according to the present invention. All electronic devices communicate each other through at least one short rang communication protocol such as Bluetooth and at least part of the smart devices communicate through wireless communication network 108 such cellular communication network Each electronic device is identified in the network by a unique BT identification number which is comprised of a manufacturing ID uniquely allocated for said device by the manufacturing company and social ID of the respective human user associated with the electronic device. This BT identification number is generated manually by the human user or automatically by a dedicated application residing on the electronic device, using it as the identification of the device when connecting through Bluetooth communication. When using Bluetooth communication as known today, the devices are using arbitrary ID number which is a default ID of the device or a given ID inserted by the user. In both options the ID's do not uniquely identify the device and it's owner. According to the present invention it is suggested to provide a new communication platform which establishes a wireless social communication network which is based establishing connection between entities using Bluetooth communication protocols and having unique BT identification numbers. The BT identification is recorded in the device Bluetooth communication setting or optionally at the name of the device which can used by the Bluetooth interface. When the electronic device checks available Bluetooth enabled device in it's proximity, the available device will be recognized with their BT ID, enabling to retrieve profile information of the respective entity through the relevant social network.

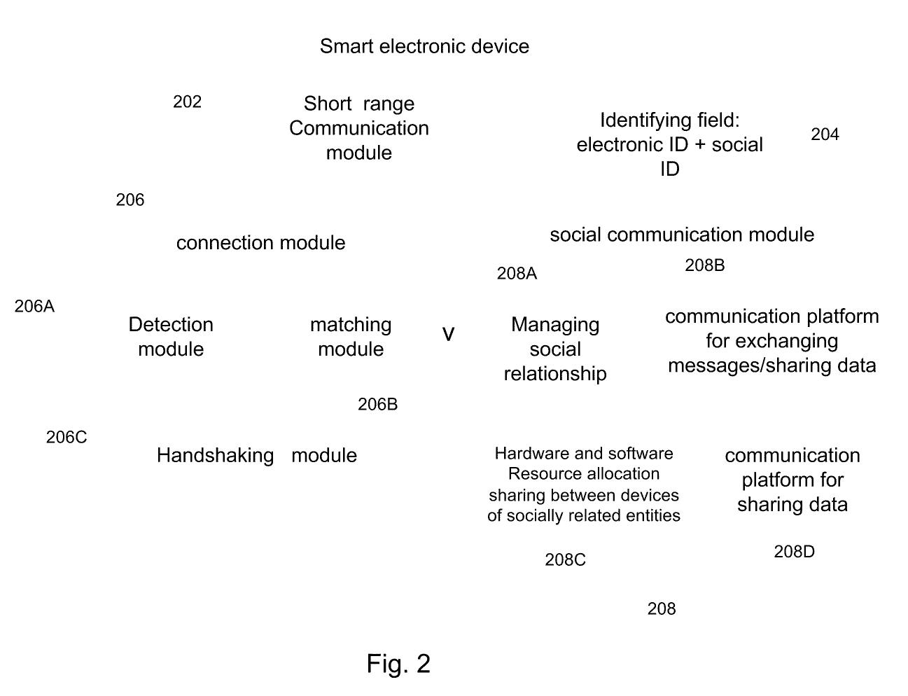

FIG. 2. illustrates a block diagram of client applications and modules residing on the mobile device. The mobile device include short range communication module 202, enabling the device to connect other devices through Bluetooth communication using the BT identification 204. The present invention provides a unique method of establishing connection between two entities using the connection module 206. The detection module 206A identifies available device in proximity to the testing device recognizing them by the BT ID, optionally the matching module 206B checks the available profile of detected entities pairs, suggesting the users to establish new social connection based on the common profile properties or according to mutual bodies of the entities. Optionally the system may update contact details according to of detected nearby devices according to their Bluetooth ID. For pair of users who asked to establish connection, the handshaking module 206C enables to create new social connection based on their BT identification. Once a social connection has been established the users become bodies in a social wireless network and are provided with following services by social communication module 208: exchange messages and data information using various communication platforms by modules 208B and 208D, managing their social relationship by module 208A by at least checking their available buddies at defined geographical location and sharing hardware software resources messages and information between bodies available at the same geographic location by module 208C

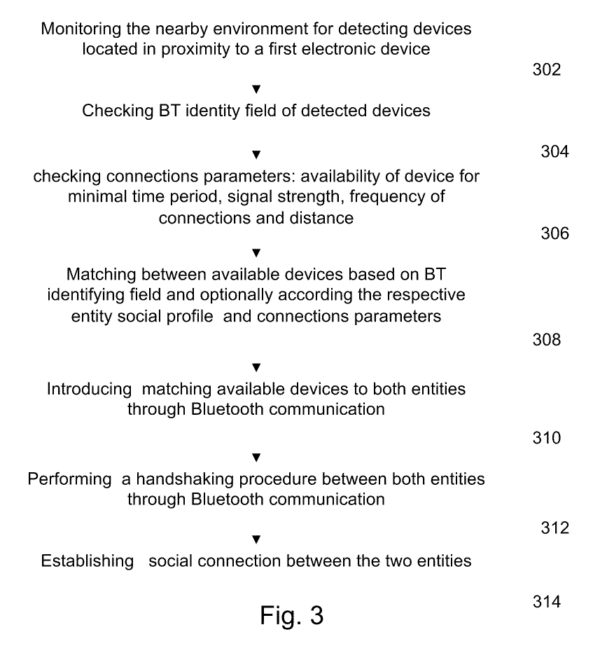

FIG. 3 is a flowchart illustrating the process of establishing new connections between entities of the wireless network in accordance with embodiments of the present invention. Each mobile device monitors periodically all available devices in proximity using Bluetooth communication 302. Each detected device is recognized by its BT ID 304, checking connection parameters and the availability of each device by measuring connection strength between the pair of devices, the distance, frequencies of times in which the detected device was available through a predefined period, and time period in which the detected device are presence in proximity to testing device step 306. These tests are used for determining the potential of establishing social connection, the tests results can be recorded for a temporary period and accumulate the data for this purpose. These detections tests can combine measurements executed through different communication protocols such as Bluetooth, WIFI RF or Infra Red. Optionally based on data received from least two antennas such as Bluetooth and WIFI, it is suggested to calculate direction of the received signal. This information can be useful for testing the potential connection with near by devices. For example the user may limit invitation for connection only with entities located in front of him. According to other embodiments of the present invention, it suggested to use directional antennas enabling to limit the detection of available devices at predefine angles around the testing device. Based on above tests and optionally by checking the social available detail a matching test is preformed 308 by giving weight to each test for selecting pairs of devices that may potential bodies. Using the social identity, the matching may locate mutual bodies for identifying potential social connection. An introduction is made between matching entities pairs 310 through the Bluetooth connection. For user pairs who agreed to make the social connection, a handshaking procedure is preformed 312 by requiring both users confirm their agreement. At the final step the users becomes buddies in the social wireless network 314. Once socially connected the user may connect each other using various messaging platform not limited to short range communication.

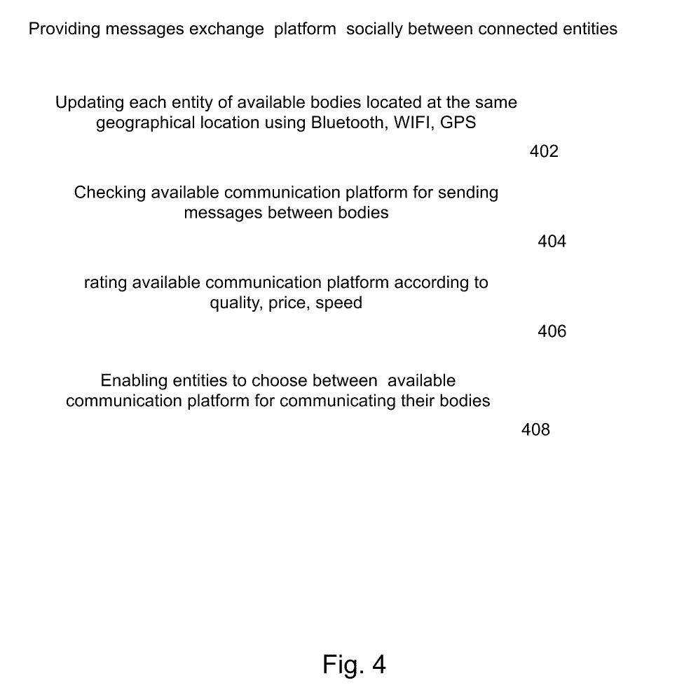

FIG. 4 is flowchart illustrating the process of providing messages and data information exchange platform, between connected entities in accordance with some embodiments of the present invention. Members of the of the social wireless network are provided with message exchange platform, enabling to choose any available service such as SMS, email, instant messaging etc, using their BT identity 402. The application informs the user of any of their bodies and the available connection routs 404, such as WIFI, cellular network or Bluetooth. The user may choose the message routing 408 according to rating data provided by the application 406, the rating based on pricing, quality and speed of each connection.

According to some embodiments of the invention it is suggested to enable the users to define Bluetooth communication profiles, each profile defines the type of connections the use wishes to be exposed to. Connection may include business type, social type, dating type or family type. At any given time the user can switch between connection types according to his preferences. The user may further define access privileges to his personal information profile according to requesting entity relationship/connection type.

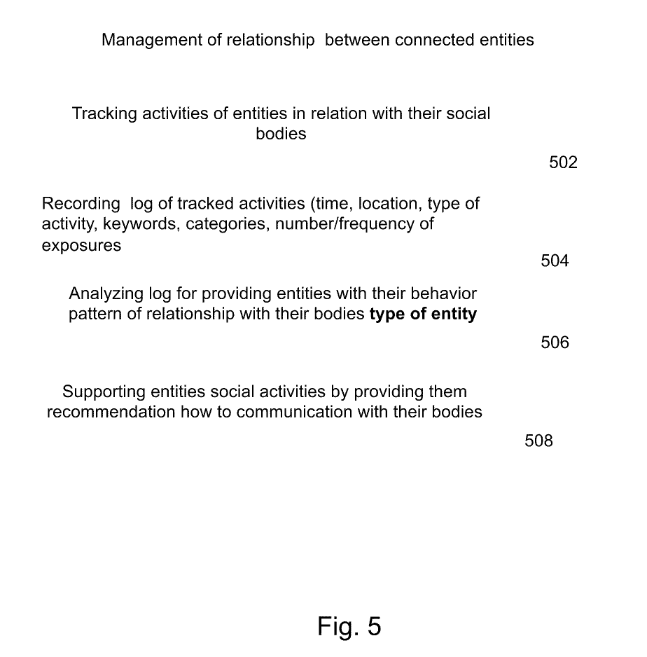

FIG. 5 is flowchart illustrating the management process of relationship between connected entities in accordance with additional embodiments of the present invention. The client application tracks user social activities 502, and create a record log of activities 504, classified according to connection frequency, context of messages, geographical location and profile. The collected data is analyzed to detect behavior patterns and to map the user relationships 506. Based on relationship mapping the user can receive recommendations to mange and improve his social connection 508 (e.g., frequencies of contacting bodies). The recommendations may include potential entities for connection according to frequency of meetings with nearby electronic devices or according to mutual bodies and profiles, schedule for connecting bodies according analyzed pattern behavior of the members.

According to some embodiments of the present invention it is suggested to enable automatic updates of a members activities according to identified meeting between members at specific geographic locations, e.g., members attending at specific event at the same time can be reported as activity of each member. A log of activities can be recorded and analyzed to detect behavior pattern. The activities can be reported to other users inviting them to join mutual activities of their bodies.

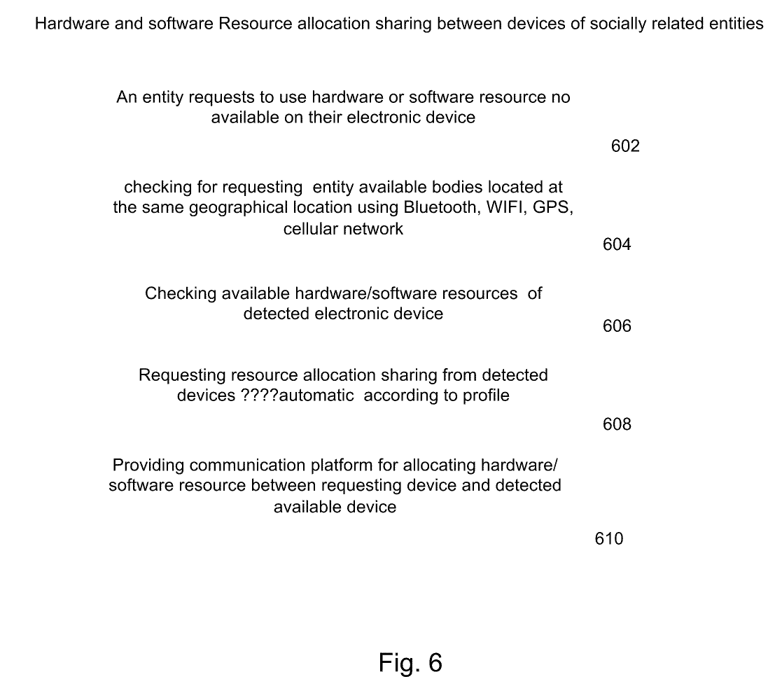

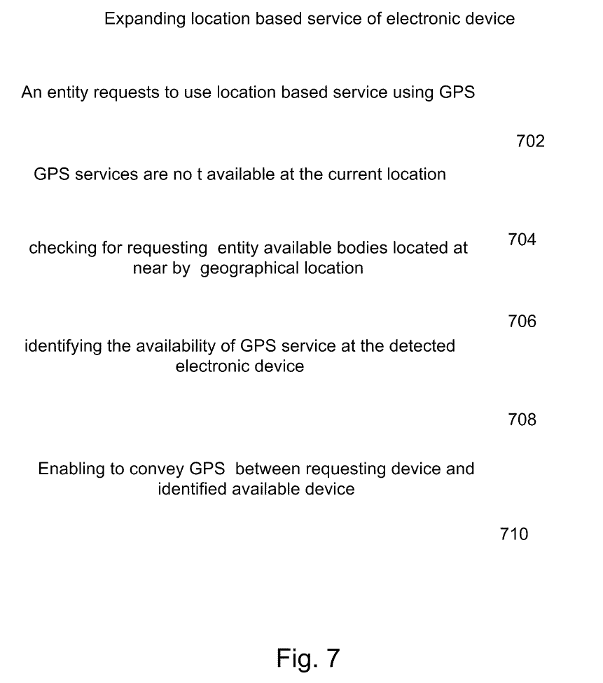

FIG. 6 is flowchart illustrating the process of hardware and software resource allocation sharing between devices of socially related entities in accordance with additional embodiments of the present invention. The platform of the created social network enables members located at the same geographical location to share hardware or software resources. One example is sharing GPS unit capabilities, where the GPS is out of communication range for one member, (see detailed explanation in FIG. 7). Other examples may include sharing memory, processing power, communication application such as Skype, camera functionality, access to data communication network such as the Internet.

An electronic device which requires a hardware of software resources which is not available in the device, can locate other members devices available in proximity and check if the available device include the requested resource. When locating such device the resource can be shared between the entities' devices.

FIG. 7 is flowchart illustrating the process of expanding location based service of electronic device in accordance with additional embodiments of the present invention. Location based service which use the GPS functionality of a mobile devices are limited in closed places where the GPS unit is blocked. According to the present invention it is suggested to use the social network for expanding the use of the location based services. The electronic device can locate available bodies in proximity of the requesting device 706 in which the GPS unit is not blocked 708. If such device is available it can share its GPS location data with the requesting device enabling it to use location based services 710. According to other embodiment of the present invention, the location information can be retrieved through communication transceiver such router, switching device or a modem, by identifying the IP address of the near by communication transceiver and determining its location accordingly. The location may be determined by combining several sources such as: GPS, a communication transceiver, and cellular antennas etc.

Optionally the members can update their exact location manually, the updates can be sent to the to the central database of the social network, enabling to provide an enhanced mapping of the wireless social members.

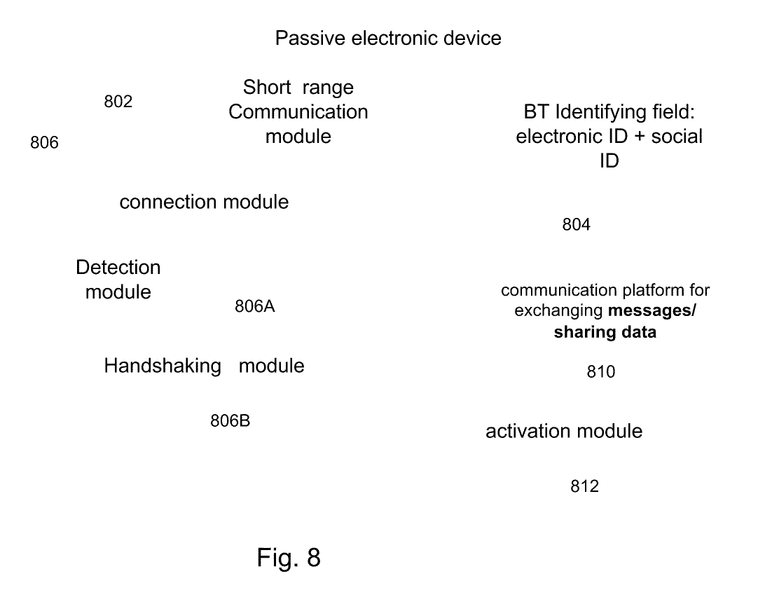

FIG. 8 is a block diagram of a passive mobile device in accordance with additional embodiments of the present invention. Passive devices such as electronic tags are enabled only for short range communication such Bluetooth or RFID using short range communication module 802, enabling the device to connect other devices through Bluetooth communication using the BT identification 804. The passive device further includes connection module 806 for establishing connection with smart electronic devices using detection module 806A for detecting near by available devices and handshaking module 806B for establishing social connection between the passive device and an entity of a smart devices. Once the passive device is socially connected to a smart device entity, various services can be provided such as tracking the location of the passive device using module 810 or activating the passive device using module 812 (e.g., locking/unlocking door).

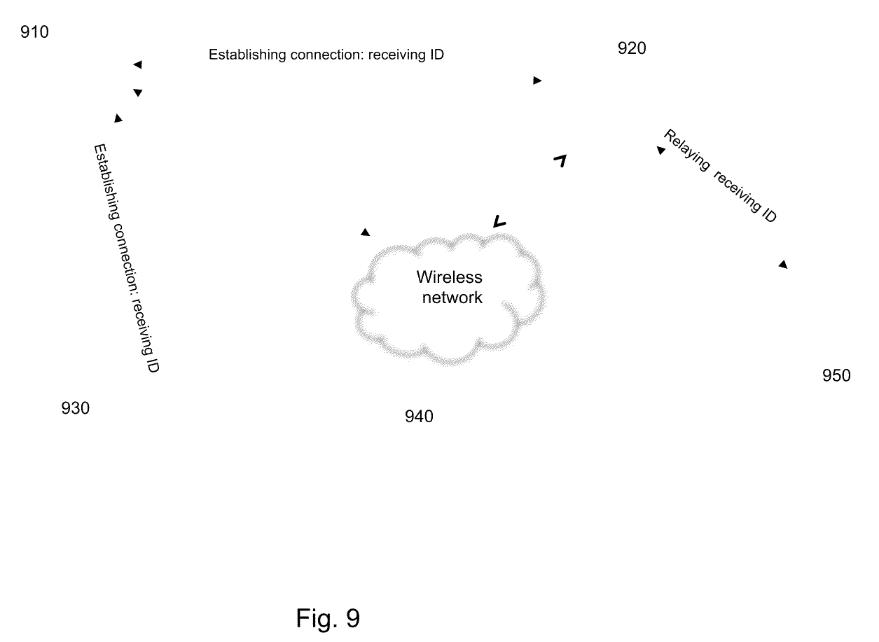

FIG. 9 is a schematic illustration of the basic connectivity between a master entity, his bodies and devices which operate in accordance with additional embodiments of the present invention. This communication configuration relates to scenarios where one entity (“master entity”) 910 supervises other entities which are associated with smart electronic devices 912 or passive electronic devices 914 (e.g., teacher in a class room). At initial phase the master device establishes list of connections of its group members using the handshaking procedure as described above. The electronic device of the master entities includes a control module which periodically or per request, checks all available devices in proximity to the master device and compare their identities to created group list, enabling the master entity to supervise the presence of its group member. In the case of a missing group member its can be located using other communication route using the cellular social network communication platform. Another option, is to use recognized available group member device as a relay device to communicate devices 950 which are out of communication range of the master device.

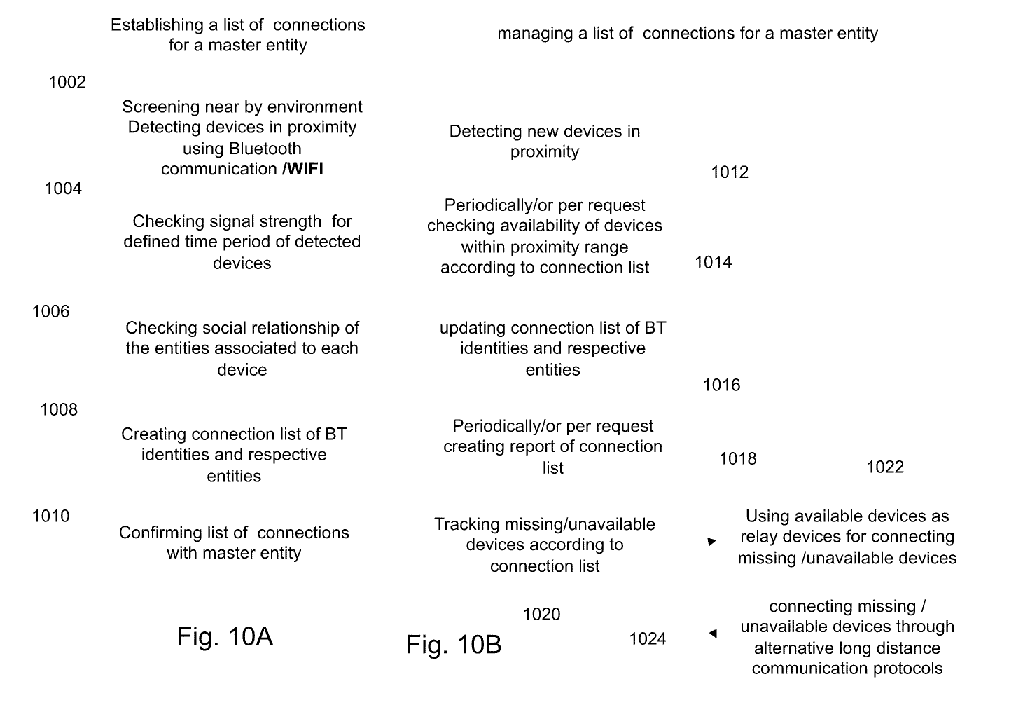

FIGS. 10A and 10B are a flowchart illustrating the process of communication between a master entity, his bodies and devices which operate in accordance with additional embodiments of the present invention. FIG. 10A illustrates the process of creating the group list. The master device screens nearby environment, optionally using directional antenna to locate available devices 1002. For each available device, the master device tests the signal strength during defined period time 1004. This test filters devices which where in closed proximity but only for short time and identify potential entities devices which may be part of the group members. At the next step master device checks the social profile for identifying relevant group members 1006 and create the group connections list 1008. At the last step the master entity confirm the group list 1010.

FIG. 10B illustrates the supervising flow of the master device. The master device continuously screens available devices to detect new devices 1012 or group members which are recognizable in a predefined area range 1014. Accordingly the master device can update 1016 and report the master entity checkup list of available group members, notifying of missing members 1018. The reports can be created periodically, per request, or according to triggering rules. Incase of missing members the master device can try and locate them 1020 using the communication platform using available communication routes 1024, such WIFI, cellular network using instant messaging, SMS or mails. Optionally the missing members can be reached using Bluetooth by using available device as relay device 1022 for communicating the missing devices which are out of the master device communication range.

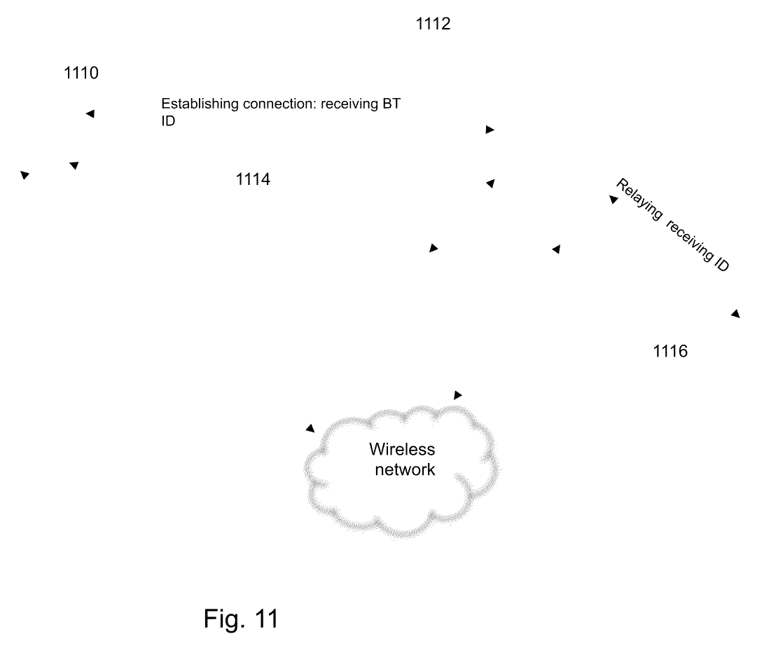

FIG. 11 is a schematic illustration of the basic connectivity between a manager entity, his bodies and devices which operate in accordance with additional embodiments of the present invention. This communication configuration relates to scenarios where one entity 1110 (“manager entity”) establishes designated group members 1112 for predefined purpose. One possible scenario, are commercial groups established by a merchant in at a specific location, connecting nearby devices which are potential buyers in proximity of the merchant store. The merchant managing device such as computer terminal 1110 having a Bluetooth communication module identifies available devices 1112 in the store and invite them to join his store group through Bluetooth communication. Passive devices 1114 are scattered around the store for establishing connection with available devices 1112, and conveying information to managing device. Users which acknowledge the invitation through a handshaking procedure as described above, become group members. The manger device can use a CRM application for recognizing returning members, track their activities in the store, send them sales offers according to their social profile or guide them through store to locate products or services. Customers who became members of the merchant group can communicate through their electronic device with merchant managing device for transferring personal details required for financial transactions. The connection between the customers and the merchant can be continued after the customer left the store using remote communication platforms. The user may receive promotional messages according to his profile and purchasing history or become affiliate of the merchant by reporting his buddies of is purchase and recommending the store. An affiliate customer can be rewarded for his promotions according to success or leads.

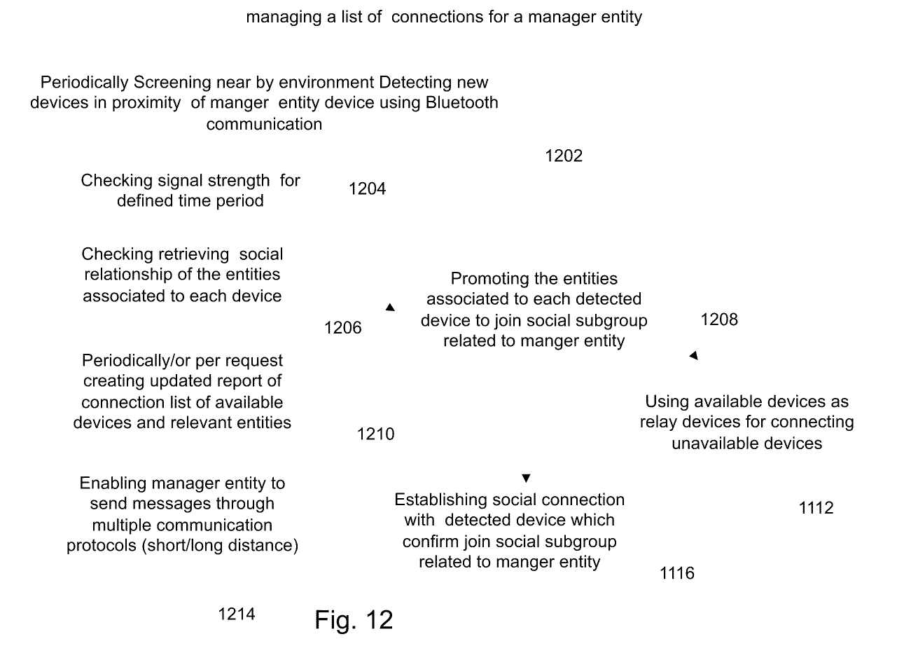

FIG. 12 is a flowchart illustrating the process of communication between a manger entity, his bodies and devices which operate in accordance with additional embodiments of the present invention. A manager entity device screens nearby environment to detect new devices entering his communication range 1202. For each entering device, the manger device checks signal strength for defined time period for filtering by passing entities 1204. The manager entity and retrieves and checks the social profile of the filtered entities 1206 and sends nearby devices an invitation to join the manager entity group 1208, such as a commercial group of a merchant. The entities of the nearby device can confirm joining the group through Bluetooth communication path 1216. Once joining the group, the members can be updated with sales information, coupons and online help to locate products through the manger terminal device. The manager entity can generate report of available devices and associated entities 1210, these reports can be used for analyzing customers behavior pattern within the store. Returning customers are easily recognized and based on their pervious activity log can receive help and price reductions. Group members may report their bodies of the their commercial activities and receive benefits from the group managing entity (e.g. the merchant store).

According to further embodiment of the present invention, it is suggested to use the platform of wireless social network to track and locate entities associated with passive electronic devices. The searching entity transmits a query to one or more bodies, to report it, in case a specific entity having BT identity is located in proximity of one of the bodies' electronic device.

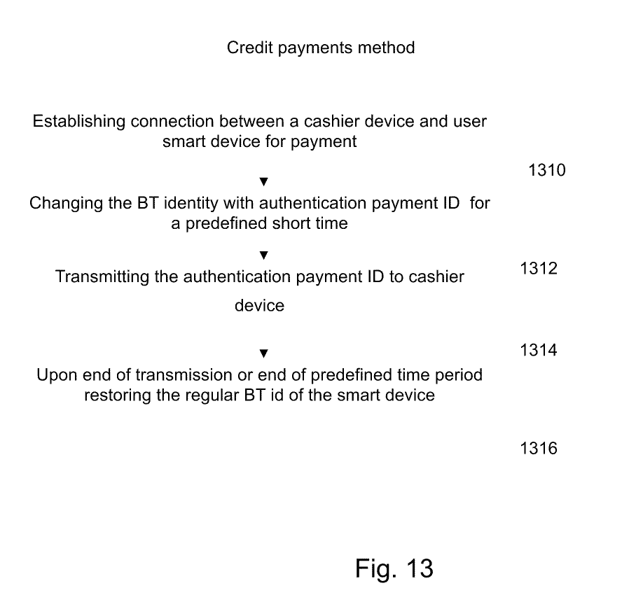

FIG. 13 is a flowchart illustrating the process of credit payment utilizing the communication platform according to the present invention. When the user approach the cashier device a Bluetooth connection is established between his smart electronic device and the cashier device. The user activates a payment module in his device. The activation of the payment module exchange the regular BT identity with an authenticated credit ID for a predefined short time period. Within this period the authenticated credit ID is transmitted to the cashier device. Optionally the transmission is targeted toward the cashier device using a directional antenna or using a blocking cover for ensuring the transmission is not received at the whole surrounding of the device. The transmission of the authenticated ID can be implemented using secured communication methodologies such as public-privet key. The electronic device may be passive device having a designated key for activating the payment module.

According to some embodiments of the present invention, passive electronic devices may be associated with personal assets such as cars or apartments. Such passive device can be used for access privileges or parking services. Optionally the passive device associated with cars can transmit advertisement for selling the car.

According to further embodiment of the present invention, its is suggested to use BT identity as an authorization code for accessing physical premises which require the user to identify using magnetic cards or biometric identification methods.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for establishing connection between at least two electronic devices, through wireless communication data network, wherein each electronic device is associated with a single entity and at least one of the entities is a human user which participates in at least one social network, said system comprising:
a connection module supported by a short range communication protocol, integrated within at least one electronic device, wherein the module includes an identifying field uniquely associated with said electronic device and associated entity, said identification field is exposed as BT identity to other electronic devices located at proximity to said first device, wherein the identification field includes at least one unique code corresponding to said electronic device and at least one code associated with ID number of the entity in a social network;
at least one repository of a cellular social network members, each member record including the identifying field, user profile and user connections to other entities,
wherein the connection module support handling the handshaking process of establishing social connection between two entities, said connection method comprising:
a detection module for measuring connection parameters of exposure time period, signal strength, distance, frequency of exposures between two electronic devices for initiating an handshaking process between two corresponding entities located in proximity to each other;
a matching module enabling to compare profiles of detected entities and notify at least one entity of a list of identified entities located in proximity having a relevant profile and according to detection module measurements;
a presentation module for displaying the matching entities and their identifying field at the screen of the electronic device;
a handshaking module enabling to send an introduction message using the short range communication protocol, and establishing connection to said second entity by receiving acknowledgment from said second entity, wherein upon establishing connection both entities are connected through a social cellular network; and
a social communication module enabling socially connected members to exchange messages through alternative communication protocols using the BT identifier not limited to short range communication.

2. The system of claim 1, wherein the short range protocol is at least one of Bluetooth, WIFI, RF, and Infra Red.

3. The system of claim 1, wherein the system further include connection algorithm enabling to evaluate connection parameters measurements and to combine at least two short range communication protocol including at least one of Bluetooth, WIFI, RF, and Infra Red.

4. The system of claim 1, wherein the alternative communication protocols include at least one of the following: TCP/IP, WAP.

5. The system of claim 1, wherein at one of the electronic device is a passive electronic tag adapted to communicate only through short range communication protocol.

6. The system of claim 1, wherein at least one electronic device is a smart mobile device adapted to communicate through short range communication protocol and long range data wireless networks for exchanging electronic messages or information.

7. The system of claim 1, wherein at least one electronic device is a stationary device adapted to communicate only through short range and operatively associated with a computerized terminal.

8. The system of claim 6, wherein the smart electronic device are functioning as communication relay device adapted to establish social connection between two electronic devices located out of the short range communication protocol.

9. The system of claim 6, wherein the smart device includes a management application enabling the associated entity to track pre-defined list of entities socially related to the first entity, and supervising their presence within predefined range.

10. The system of claim 6, wherein the smart device includes a management application enabling the associated entity to track pre-defined list of entities socially connected to the first entity, and supervising their presence at any location in the range of at least one electronic device associated to entities socially connected to the first entity and having long distance communication with the electronic device of the first entity.

11. The system of claim 1, wherein the alternative communication platform include at least one of the following communication applications: IM, SMS, emails or chat.

12. The system of claim 1, further comprising a tracking module for locating entities associated with passive electronic devices, wherein a searching entity transmits a query to one or more bodies, to report it, in case a specific entity having BT identity is located in proximity of one of the bodies' electronic device.

13. The system of claim 1, wherein each electronic device scans the nearby environment for locating bodies' electronic devices, wherein detected devices have direct connection through short range communication protocol to exchange messages and information.

14. The system of claim 13 wherein the social communication module provide the users with information of available communication platform for connecting available members, said information including communication cost, quality of connection, and speed of connection.

15. The system of claim 1, wherein the electronic device further includes a module for calculating the direction of the received signals from near by electronic device enabling to limit the detection of available devices at predefine angles around the electronic device, utilizing at least one of: directional antennas, and a pair of antennas.

16. The system of claim 1, further comprising a location module for expanding the use of the location based services for a requesting device in which the GPS is out of communication range, wherein the electronic device can locate available bodies in it's proximity in which the GPS unit is not blocked, when the available device the GPS location data is shared with the requesting device enabling it to use location based services.

17. The system of claim 1, further comprising a payment module enabling authenticated payment by the electronic device, wherein the authenticated payment is achieved by replacing the BT identity for a short time period with authenticated ID number and transmitting said number to a designated second electronic device through a short communication protocol.

18. A method for establishing connection between at least two electronic devices, through wireless communication data network, wherein each electronic device is associated with a single entity and at least one of the entities is a human user which participates in at least one social network, said method comprising:
creating an identifying field uniquely associated with said electronic device and associated entity, said identification field is exposed as BT identity to other electronic devices located at proximity to said first device network through a short range communication protocol, wherein the identification field includes at least one unique code corresponding to said electronic device and at least one code associated with ID number of the entity in a social network;
establishing social connection between two entities through a handshaking process, said process comprising:
measuring connection parameters including exposure time period, distance and signal strength, and exposure frequency between two electronic devices for initiating an handshaking process between two corresponding entities located in proximity to each other;
matching profiles of detected entities and notify at least one entity of a list of identified entities located in proximity having a relevant profile and according measurements of connection parameters;
presenting list of matching entities; and
sending an introduction message using the short range communication protocol, and establishing connection to said second entity by receiving acknowledgment from said second entity, wherein upon establishing connection both entities are connected through a social cellular network;
saving cellular social network members records including the identifying field, user profile and user connections to other entities; and
exchanging messages between socially connected members to through alternative communication protocols using the BT identifier not limited to short range communication.

19. A system for establishing connection between at least two electronic devices, through wireless communication data network, wherein each electronic device is associated with a single entity and at least one of the entities is a human user which participates in at least one social network, said system comprising:
a connection module supported by a short range communication protocol, integrated within at least one electronic device, wherein the module includes an identifying field uniquely associated with said electronic device and associated entity, said identification field is exposed as BT identity to other electronic devices located at proximity to said first device, wherein the identification field includes at least one unique code corresponding to said electronic device and at least one code associated with ID number of the entity in a social network;
at least one repository of a cellular social network members, each member record including the identifying field, user profile and user connections to other entities,
wherein the connection module support handling the handshaking process of establishing social connection between two entities, said connection method comprising:
a detection module for measuring connection parameters of exposure time period, signal strength, distance, frequency of exposures between two electronic devices for initiating an handshaking process between two corresponding entities located in proximity to each other;
a presentation module for displaying the matching entities and their identifying field at the screen of the electronic device; and
a handshaking module enabling to send an introduction message using the short range communication protocol, and establishing connection to said second entity by receiving acknowledgment from said second entity, wherein upon establishing connection both entities are connected through a social cellular network; and
a social communication module enabling socially connected members to exchange messages or information through alternative communication protocols using the BT identifier not limited to short range communication.
